(19) United States
(12) Patent Application Publication
(10) Pub. No.: US 2026/0302678 A1
(43) Pub. Date: Oct. 1, 2026

(54) COMPOSITE CAP DESIGN FOR HIGH VOLTAGE ELECTRICAL CONNECTIONS

(71) Applicant: Freudenberg-NOK General Partnership, Plymouth, MI (US)

(72) Inventor: Darin BATTLES, Dahlonega, GA (US)

(21) Appl. No.: 19/096,933

(22) Filed: Apr. 1, 2025

(51) Int. Cl. H01R 13/46

(52) U.S. Cl. CPC H01R 13/46

(57) ABSTRACT

A cap includes a cap having a base wall and a first annular sidewall extending from one side of the base wall. The annular sidewall includes a radially inwardly extending rib and a radially outwardly extending rib. A retaining ring has an annular wall having a distal radially inwardly extending rib and a proximal radially inwardly extending rib. The distal radially inwardly extending rib is axially spaced from the proximal radially extending rib, wherein the cap is received in the retaining ring in a first mode with the radially outwardly extending rib being disposed between the distal radially inwardly extending rib and the proximal radially inwardly extending rib and in a second mode the retaining ring is pressed so that the proximal radially extending rib passes over the radially outwardly extending rib and the distal radially inwardly extending rib surrounds the radially inwardly extending rib of the cap.

### FIELD

The present disclosure relates to a composite cap design for high voltage electrical connections.

### BACKGROUND

This section provides background information related to the present disclosure which is not necessarily prior art.

Electrical vehicles and other battery powered systems often utilize a battery pack having numerous battery cells connected by bus bars. Fasteners can be utilized the connect the bus bars to one another and to the battery cells. The bus bar connections are covered by rigid, electrically insulative covers to prevent contact with the high voltage electrical connections. The covers can include access openings to facilitate the fasteners. The cap described here is intended to cover these openings to prevent short circuits and guard against electrical hazards.

### SUMMARY

This section provides a general summary of the disclosure, and is not a comprehensive disclosure of its full scope or all of its features.

According to an aspect of the present disclosure, a cap system for electrical connectors includes an electrical connection cover having an annular boss with an undercut feature. A cap is disposed over the annular boss and is made from elastomeric material and includes having a base wall and a first annular sidewall extending from one side of the base wall. The annular sidewall includes a radially inwardly extending rib spaced from the base wall and a radially outwardly extending rib axially spaced from the radially inwardly extending rib. The radially inwardly extending rib is received below the undercut feature. A retaining ring made from a rigid material and having an annular wall having a distal radially inwardly extending rib and a proximal radially inwardly extending rib, the distal radially inwardly extending rib being axially spaced from the proximal radially extending rib, wherein the cap is received in the retaining ring in a first mode with the radially outwardly extending rib being disposed between the distal radially inwardly extending rib and the proximal radially inwardly extending rib and in a second mode the retaining ring is pressed so that the proximal radially extending rib passes over the radially outwardly extending rib and the distal radially inwardly extending rib surrounds the radially inwardly extending rib of the cap to prevent the cap from being displaced from the annular boss.

According to a further aspect, the elastomeric material of the cap and the rigid material of the retaining ring are electrically insulative.

According to an aspect, a sealing cap for electrical connectors includes a cap made from elastomeric material and having a base wall and a first annular sidewall extending from one side of the base wall. The annular sidewall includes a radially inwardly extending rib spaced from the base wall and a radially outwardly extending rib axially spaced from the radially inwardly extending rib. A retaining ring is made from plastic and has an annular wall having a distal radially inwardly extending rib and a proximal radially inwardly extending rib. The distal radially inwardly extending rib is axially spaced from the proximal radially extending rib, wherein the cap is received in the retaining ring in a first mode with the radially outwardly extending rib being disposed between the distal radially inwardly extending rib and the proximal radially inwardly extending rib and in a second mode the retaining ring is pressed so that the proximal radially extending rib passes over the radially outwardly extending rib and the distal radially inwardly extending rib surrounds the radially inwardly extending rib of the cap to prevent the cap from being displaced.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a cross sectional perspective view of the cap system for electrical connectors shown in a fully engaged position according to the principles of the present disclosure;

FIG. 2 is a cross sectional view of the cap system for electrical connectors shown separate from the cover;

FIG. 3 is a cross sectional view of the cap system for electrical connectors shown being engaged position according to the principles of the present disclosure; and

FIG. 4 is a cross sectional view of the cap system for electrical connectors shown in a partially engaged position according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

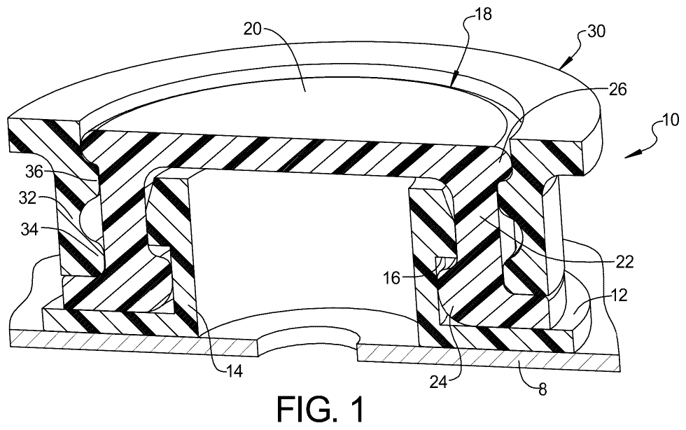

With reference to FIG. 1, a cap system 10 for an electrical connector 8 includes an electrical connection cover 12 having an annular boss 14 with an undercut feature 16. A cap 18 is disposed over the annular boss 14 and includes a base wall 20 and a first annular sidewall 22 extending from one side of the base wall 20. The annular sidewall 22 includes a radially inwardly extending rib 24 spaced from the base wall 20 and a radially outwardly extending rib 26 axially spaced from the radially inwardly extending rib 24.

The radially inwardly extending rib 24 is received below the undercut feature 16. The cap 18 is received in a retaining ring 30 that includes an annular wall 32 having a distal radially inwardly extending rib 34 and a proximal radially inwardly extending rib 36. The distal radially inwardly extending rib 34 is axially spaced from the proximal radially extending rib 36.

The cap 18 is preferably made from an electrically insulative flexible elastomeric material. The retaining ring 30 is preferably made from an electrically insulative rigid material such as, but not limited to plastic.

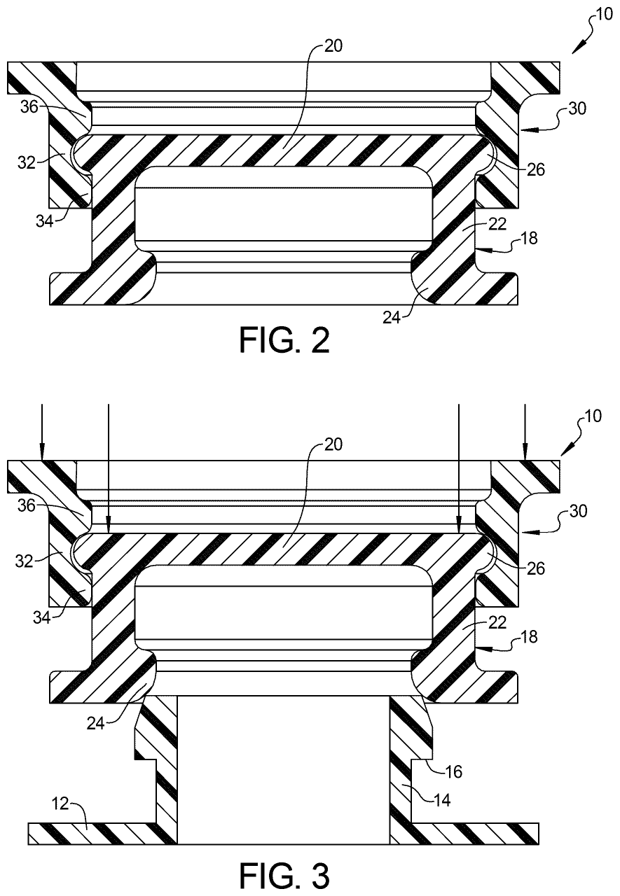

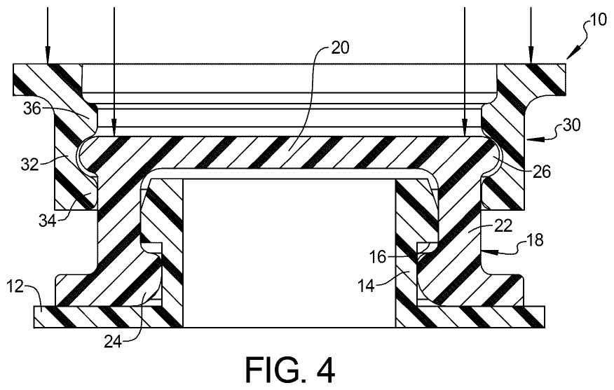

FIG. 2 illustrates the cap 18 and the retaining ring 30 of the cap system 10 shown separate from the cover. FIG. 3 illustrates the sealing cap system 10 being engaged with the annular boss 14 of the cover 12. The cap 18 is received in the retaining ring 30 with the radially outwardly extending rib 26 being disposed between the distal radially inwardly extending rib 34 and the proximal radially inwardly extending rib 36 of the retaining ring 30. FIG. 4 shows the sealing cap system 10 in a partially engaged position with the radially inwardly extending rib 24 of the cap 18 engaged below the undercut feature 16 of the annular boss 14.

As shown in FIG. 1, the retaining ring 30 is pressed downward to a fully assembled position so that the proximal radially extending rib 36 passes over the radially outwardly extending rib 26 of the cap 18. The proximal radially inwardly extending rib 36 is disposed under the radially outwardly extending rib 26 of the cap 18 and the distal radially inwardly extending rib 34 surrounds the radially inwardly extending rib 24 of the cap 18 to prevent the cap 18 from being displaced from the annular boss 14. The fully assembled position of the retaining ring 30 relative to the cap 18 provides a visual indication that the sealing cap system 10 is in the locked position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cap system for electrical connectors, comprising:
an electrical connection cover having an annular boss with an undercut feature;
a cap made from elastomeric material and having a base wall and a first annular sidewall extending from one side of the base wall, the annular sidewall including a radially inwardly extending rib spaced from the base wall and a radially outwardly extending rib axially spaced from the radially inwardly extending rib, the cap being disposed over the annular boss with the radially inwardly extending rib received below the undercut feature; and
a retaining ring having an annular wall having a distal radially inwardly extending rib and a proximal radially inwardly extending rib, the distal radially inwardly extending rib being axially spaced from the proximal radially extending rib, wherein the cap is received in the retaining ring in a first mode with the radially outwardly extending rib being disposed between the distal radially inwardly extending rib and the proximal radially inwardly extending rib and in a second mode the retaining ring is pressed so that the proximal radially extending rib passes over the radially outwardly extending rib and the distal radially inwardly extending rib surrounds the radially inwardly extending rib of the cap to prevent the cap from being displaced from the annular boss.

2. The cap system according to claim 1, wherein the elastomeric material of the cap and the retaining ring are electrically insulative.

3. A cap for electrical connectors, comprising:
a cap made from elastomeric material and having a base wall and a first annular sidewall extending from one side of the base wall, the annular sidewall including a radially inwardly extending rib spaced from the base wall and a radially outwardly extending rib axially spaced from the radially inwardly extending rib; and
a retaining ring having an annular wall having a distal radially inwardly extending rib and a proximal radially inwardly extending rib, the distal radially inwardly extending rib being axially spaced from the proximal radially extending rib, wherein the cap is received in the retaining ring in a first mode with the radially outwardly extending rib being disposed between the distal radially inwardly extending rib and the proximal radially inwardly extending rib and in a second mode the retaining ring is pressed so that the proximal radially extending rib passes over the radially outwardly extending rib and the distal radially inwardly extending rib surrounds the radially inwardly extending rib of the cap to prevent the cap from being displaced.

4. The cap system according to claim 3, wherein the elastomeric material of the cap and the plastic of the retaining ring are electrically insulative.
